(19) United States
(12) Patent Application Publication
(10) Pub. No.: US 2021/0150448 A1
(43) Pub. Date: May 20, 2021

(54) METHOD AND SYSTEM FOR PROGRAM MANAGEMENT

(71) Applicant: salesforce.com, inc., San Francisco, CA (US)

(72) Inventors: Margaret Elizabeth Gray, San Francisco, CA (US); Daniel Walton Venor, Encinitas, CA (US); Tarren James Anderson, Burnsville, MN (US); Claire Markham, San Francisco, CA (US); Bethany Breisnes, Vancouver (CA); Scott Thomas Pelak, Grand Rapids, MI (US); Willi Watkins, Chicago, IL (US); Bharathi Muniswamy, Clarksville, MD (US); Kelley A. Bevans, Seattle, WA (US); Sophia Dias, San Francisco, CA (US); Ashwin Nitin Mogral, Fremont, CA (US); Gagan Puneet Kaur Sandhu, Fremont, CA (US); Monica Ramachandran, Mahwah, NJ (US); Jaclene Roshan, Brooklyn, NY (US)

(73) Assignee: salesforce.com, inc., San Francisco, CA (US)

(21) Appl. No.: 16/793,358

(22) Filed: Feb. 18, 2020

Related U.S. Application Data
(60) Provisional application No. 62/937,178, filed on Nov. 18, 2019.

(51) Int. Cl. G06Q 10/06; G06Q 30/00; G06Q 10/10; G06F 16/22

(52) U.S. Cl. CPC G06Q 10/063114; G06Q 30/016; G06Q 30/0279; G06F 16/22; G06Q 10/10

(57) ABSTRACT

A method and a program management system are described. The program management system enables a user to enter data related to the services and programs offered to a client based on a standardized program management data model.

### CROSS-REFERENCE TO RELATED APPLICATIONS

This application claims the benefit of U.S. Provisional Application No. 62/937,178, filed Nov. 18, 2019, which is hereby incorporated by reference.

### TECHNICAL FIELD

One or more implementations relate to the field of program management systems; and more specifically, to manage programs of a nonprofit organization.

### BACKGROUND ART

Nonprofit organizations and similar entities offer one or more service through programs to a set of clients. The clients of the nonprofit organization are beneficiaries of these services and generally interact with one or more program managers of the nonprofit organization. A program manager may use a program management tool to track the services and programs offered to these clients. A program management tool typically allows a program manager of (e.g., an employee of the nonprofit organization or a contractor) to view and/or modify data related to one or more clients such as programs that the clients are enrolled in and services that are offered to these clients as part of the programs, etc.

Program management systems can be services offered in a multi-tenant cloud computing platform. A multi-tenant cloud computing platform supports one or multiple services that are made available to tenants of the multi-tenant cloud computing platform. The services are sets of functions, applications, and/or resources that may be made available on-demand to the tenants of the multi-tenant cloud computing platform. The tenants of the multi-tenant cloud computing platform can leverage these services to support their organization. Thus, an organization of a tenant does not need to be concerned with building and/or maintaining the provided services, but instead makes use of the services when needed (e.g., in response to a demand from a tenant). The services may communicate with each other and/or with one or more electronic devices external to the multi-tenant cloud computing platform via one or more Application Programming Interfaces (APIs) (e.g., a Representational State Transfer (REST) API).

The multi-tenant cloud computing platform can also provide a set of resources to tenants. For example, the resources may include a set of databases and the services use data stored within the set of databases. The set of databases may each comprise one or more database objects that are managed by a Database Management System (DBMS). Each database object may include a number of records and each record may comprise a set of fields.

A database may comprise one or more database objects that are managed by a Database Management System (DBMS), each database object may include a number of records, and each record may comprise of a set of fields. A record may take different forms based on the database model being used and/or the specific database object to which it belongs; for example, a record may be: 1) a row in a table of a relational database; 2) a JavaScript Object Notation (JSON) document; 3) an Extensible Markup Language (XML) document; 4) a key-value pair; etc. A database object can be unstructured or have a structure defined by the DBMS (a standard database object) and/or defined by a user (custom database object).

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 is a block diagram of a system that includes a program management system.

FIG. 2A illustrates a graphical user interface (GUI) that can be displayed on the customer system and used by a user to access the program management system.

FIG. 2B illustrates a GUI that can be displayed on the customer system and used by a user to access the program management system.

FIG. 2C illustrates a GUI that can be displayed on the customer system and used by a user to access the program management system.

FIG. 3A illustrates a flow diagram of exemplary operations for generation of records associated with a service delivery object.

FIG. 3B illustrates a flow diagram of exemplary operations for generation of records associated with a program engagement object.

FIG. 4A is a block diagram of a multi-tenant distributed cloud computing platform supporting the program management system.

FIG. 4B is a block diagram of a multi-tenant distributed cloud computing platform supporting the program management system.

### DETAILED DESCRIPTION

The following description describes a method and program management system that provides efficient program management based on a data model.

In the following description, numerous specific details such as implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

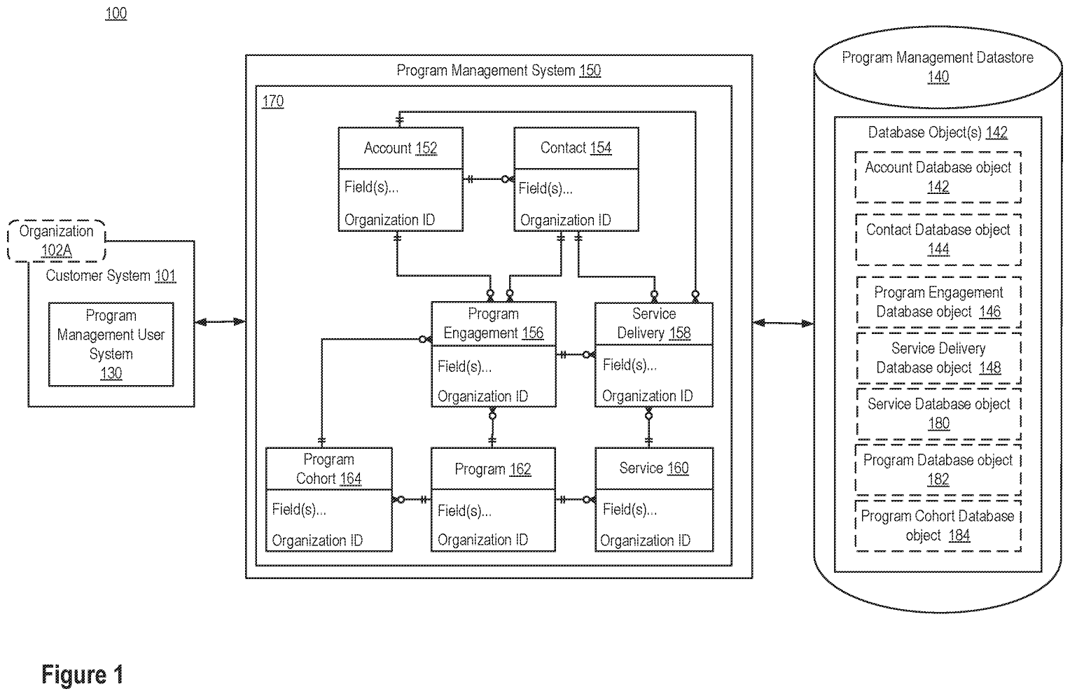

FIG. 1 is a block diagram of a system that includes a program management system.

The program management system 150 is operative to provide program management services to one or more organizations. The program management system 150 provides these services based on a new data model, which includes a set of objects and relationships between these objects. The program management system 150 can include additional elements and subsystems that are not illustrated or further discussed herein. The components of the program management system 150 and related systems illustrated in FIG. 1 are shown for sake of clarity and conciseness. One skilled in the art would appreciate that these systems and components would include additional components and systems.

In the following description an organization refers to an entity for which an instance of a program management service can be deployed. The organization typically includes multiple users. Each user may have a role within the organization. For example, a user can be an administrator of the system that is allowed to modify and update different features of the program management system 150. In another example, a user can be a program manager that is allowed to view, update, and add data related to program management. In some implementations, each user of the program management system 150 may be associated with a permission level. The permission level allows the user to access and modify data associated with one or multiple data objects in the program management system 150. In some implementations, a user may be associated with a “manage” permission level, which is a high-level permission set that gives create, read, write, and delete permissions to the program object, the program cohort object, the program engagement object, and the service and service delivery objects. A user may be associated with a “Deliver” permission level, which is a lower level permission set that gives create, read, write, permissions to Program Engagement and Service Delivery objects; and read permissions to Program, Program Cohort, & Service objects. A user may be associated with a “View” permission level, which is a read only permission set that gives read permissions to view the Program, Program Cohort, Program Engagement, Service & Service Delivery objects.

A user can be represented with a user object. As it will be described in further details below a program manager can manage and follow the progress of one or more services and programs offered to a client of the organization through the program management system 150. In the description herein, implementations will be described with respect to users and/or clients of a single organization. However, one of ordinary skill in the art would understand that the program management system may be implemented in a multi-tenant platform and in that case the implementations described herein can be performed to support the deployment of multiple instances of the program management system for multiple organizations.

The program management system 150 is coupled with a customer system 101. The customer system 101 may include one or more network devices on which a program management user system 130 runs. The program management user system 130 provides an interface or ‘front-end’ to access and enter data into the program management system 150. A user of a customer system 101 can interact with one or more components of the program management system 150 through the user interface provided by the program management user system 130. The program management user system 130 can be a specialized local client application or a general-purpose application such as web browsers. The user that belongs to organization 102A can use the customer system 101 to enter field values for each one of the objects of the data model 170. In some implementations, the customer system 101 may interface with an instance of the program management system 150 via an API. Any number of customer systems can interface with separate instances of the program management system 150 via an API of the program management system 150.

The program management system 150 allows users of an organization to log and track information related to clients and services and programs in which the clients are enrolled. The program management system 150 interfaces with a set of customer systems (e.g., customer system 101). The program management system 150 can be built based on a data model 170 that includes data objects and relationships defined between these data objects that allow the logging and tracking of program management for clients of an organization. The data model 170 includes an account object 152, a contact object 154, a program engagement object 158, a service delivery object 158, a service object 160, a program object 162, and a program cohort object 164. The data model 170 further includes multiple relationships that link the objects. The relationship between two objects is a lookup relationship.

In the following description a contact object 154 refers to a representation of a person that is to participate in a program, receive services and/or that is to participate in the delivery of services. For example, a client that is to receive services from an organization can be a particular instance of the contact object (i.e., a particular person receiving services). In another example, a program manager or a volunteer that contributes to the delivery of services and programs to clients can be a particular instance of the contact object. In some implementations, a contact object may include one or more of the following fields: a name field, an email field, a birthdate field, one or more phone number fields, a mailing address field, a client identifier field, which is a text field to store a customer facing client ID, an emergency contact field that is used to store a name of a person that can be contacted in case of an emergency for the contact, an emergency contact phone number field that is used to store a phone number of the emergency contact person, a photo file identifier field, a preferred communication method field that is used to identify the communication method (e.g., phone, email, text, etc.) that is preferred by the contact person, a client indicator field that indicates that the contact person has the role of a client. In some implementations, when the program management system 150 is a multi-tenant system, the contact object 154 includes an organization field that is used to store an identifier of an organization. In some implementations, the contact object 154 may include additional or fewer fields without departing from the scope of the implementations described herein. The contact object 154 is related to or linked to other objects of the data model 170. The contact object 154 is linked to the account object 152, the service delivery object 158, the program engagement object 156.

In some implementations, a client may be enrolled in one or more programs. When a client is enrolled in a program, a program manager may follow the progress of the client in relation with this program. The type of programs may depend on the type of the organization to which the program manager belongs. For example, the programs can include a job search program, a job readiness program, a literacy program, an afterschool program, a nutrition program, a mental health program, an animal rescue program, etc.

An account object 152 refers to a representation of a set of clients that can be linked as being part of the same group. For example, an account can represent a set of clients that belong to the same household (e.g., a same family, persons living at the same address (e.g., roommates), clients that are recipients of the same service, etc.). In some implementations, the account object 152 may include a contact field that is used to store one or more client identifiers that are part of the same household. In some implementations, when the program management system 150 is a multi-tenant system, the account object 152 includes an organization field that is used to store an identifier of an organization. In some implementations, the account object 152 may include additional or fewer fields without departing from the scope of the implementations described herein. The account object 152 is linked to the contact object 154, the program engagement object 156, and the service delivery object 158.

A program object 162 is a data object used in the program management system 150 by users to track each of the programs an organization is running. A program is a high-level grouping of services or activities around a thematic area (e.g., Workforce Development Program, Nutrition Program, Park Clean Up Program). In some implementations, the program object 162 includes the following fields: a program summary field that is to be used to include a name for the program, a status field (which can have any one of the following values, in some implementations, “Planned,”, “Active,” “Completed,” or “Cancelled” indicating the stage of development of the program), a target population field that is to be used to include a range of ages or a definition of the target population for the program (e.g., target population can be children between 5-10y, adults between 40-55, women, etc.), a start date field that is to be used to store a start date for the program, an end date field that is to be used to store an end date for the program, and a program issue area field that is to be used to indicate the thematic area the program is focused on (e.g., Housing, Education, Employment). In some implementations, when the program management system 150 is a multi-tenant system, the program object 162 includes an organization field that is used to store an identifier of an organization. The program object 162 is linked with the program cohort object 164, the program engagement object 156, and the service object 160. While the program object 162 is described as including multiple fields, some of the described fields can be optional and may not be included in some implementations. In other implementations, the program object 162 may include additional fields without departing from the scope of the implementations described herein.

A program engagement object 156 is a data object used in the program management system 150 by users to define how a contact or account relate to a particular program. In some implementations, the program engagement object 156 can be used to show that a client is enrolled in a program, a volunteer is actively working with a program offering, or a referral partner is closely tied to a program offering. Additionally or alternatively, the program engagement object 156 can be used by the program management system 150 to determine the clients that are engaged with a particular program. For example, the program management system 150 may be operative to generate a report to a user of the organization 102A on the multiple clients that are engaged in a particular program by looking up records of database objects associated with the contact object 154 and the program engagement object 156 greatly simplifying the report generation processes with respect to program engagement. The program engagement object 156 also allows to track an individual's progress through a program by showing what stage they are in (e.g., “applied,” “active”, “complete,” etc.).

In some implementations, the program engagement object 156 includes the following fields: a contact field, which is used to store an identifier of a client or an actor (e.g., program manager, volunteer, doctor, counselor, etc.) in the program management system 150 for which progress of a program is to be monitored, a stage field (which can be used to store one of the following values: “Applied,” “Enrolled,” “Active,” “Complete,” “Withdrawn” that indicates the progress of a client with respect to a program), an application date field, which is used to store a date at which a client applies for a program, a start date field, which is used to store a date at which a client starts a program, an end date field, which is used to store a date at which a client ends a program, a target population field, which is used to store a name of a population towards which the program is targeted, and a role field (e.g., Client, Volunteer, Staff) which identifies the type of the entity (here identified by the contact field) engaged in a particular program. Files (e.g., a pdf of program application or the client's CV) can also be attached to the program engagement object. In some implementations, when the program management system 150 is a multi-tenant system, the program engagement object 156 includes an organization field that is used to store an identifier of an organization. The program engagement object 156 has lookup relationships with the program object 162, the contact object 154, the account object 152, the service delivery object 158, and the program cohort object 164. While the program engagement object 156 is described as including multiple fields, some of the described fields can be optional and may not be included in some implementations. In other implementations, the program engagement object 156 may include additional fields without departing from the scope of the implementations described herein.

The program cohort object 164 is a data object used in the program management system 150 by users to segment the clients in a program into different groups based on predefined criteria. The criteria can include, but are not limited to, a time interval (e.g., Spring 2018 Workforce Development Program Cohort), the funder of the program (e.g., Workforce Development Program funded by Acumen), the location of the program (e.g., Oakland Workforce Development Program). The program cohort object 164 provides another mechanism of breaking down programs as defined by each individual organization. The program cohort object 164 can be used by a reporting system (which can be part of the program management system 150) to create reports for the nonprofit/organization. The program cohort object 164 includes fields such as a program field that is used to store an identifier of a program, a description field that provides details of what the cohort is (e.g., segmentation criteria), Program Cohort field that is used to store a name of the program cohort, a location field that is used to store a location for the multiple programs grouped under a program cohort, a start date field that is used to store a date at which the grouping of the program engagements has been initiated, an end date field that is used to store a date at which the grouping of the program engagements under this program cohort has ended, and a status field that is used to store a combined status for the group of program engagements. In some implementations, when the program management system 150 is a multi-tenant system, the program cohort object 164 includes an organization field that is used to store an identifier of an organization. The program cohort object 164 has lookup relationships to the program object 162 and the program engagement object 156. While the program cohort object 164 is described as including multiple fields, some of the described fields can be optional and may not be included in some implementations. In other implementations, the program cohort object 164 may include additional fields without departing from the scope of the implementations described herein.

The service object 160 is a data object used in the program management system 150 by users to define the actual activities an organization provides to the community or individuals they are intending to help (e.g., the client). The type of services varies widely depending on the type of the organization. A service could be teaching a class/workshop, delivering physical products to people (such as food, clothing, and/or water), or cleaning up a neighborhood, etc. In some implementations, the service object defines a service with respect to a “Unit of Measurement” allowing the use of a consistent unit of measure of how that service is delivered (e.g., hours, pounds of food, number of vaccines given, number of appointments, etc.). The services can be offered by the organization 102A or by other organizations and entities different from the organization 102A but may be tracked by this organization as part of the program management system 150. The service object 160 includes fields such as a service name field, a program field (which values can be used to look up records of the program object), a description of the service field, a start date field, an end date field, a status of the service field, and a unit of measurement field. In some implementations, when the program management system 150 is a multi-tenant system, the service object 160 includes an organization field that is used to store an identifier of an organization. The service object 160 has lookup relationships to the program object 162, and to the service delivery object 158. While the service object 160 is described as including multiple fields, some of the described fields can be optional and may not be included in some implementations. In other implementations, the service object 160 may include additional fields without departing from the scope of the implementations described herein.

The service delivery object 158 is a data object used in the program management system 150 by users to record each time a service actually happens (i.e., is actually delivered to a client). The service delivery object 158 captures through the object's fields who received that service, when and in what quantity. It also captures who delivered the service to the client. In some implementations, each time a service is delivered a new service delivery record is created. The service delivery object 158 becomes a ledger or log of all the services that have been delivered to a client or the community of clients over time. The service delivery object 158 includes fields such as a service delivery name field, service field (which values can be used to looks up records of the service object), a contact field (which values can be used to look up records of the contact object), a program engagement field to indicate the contact's engagement with a specific program, a service delivery date field, quantity of service delivered field, unit of measurement field (which is auto-populated based on the service selected, in some implementations) and a field to record who the service was delivered by. The service delivery name field is used to store a name for a service delivery instance in which a service is delivered to a client. The contact field is used to store an identifier of a client that is to receive the service. The service field is used to store an identifier of the service that is to be delivered to the client. The service delivery date field is used to store a date at which the service is delivered to the client. The quantity of service delivered field is used to store the quantity (e.g., in terms of the number of unit of measurement) that is delivered to the client. In some implementations, when the program management system 150 is a multi-tenant system, the service delivery object 158 includes an organization field that is used to store an identifier of an organization. The service delivery object 158 has lookup relationships to the program engagement object 156, the contact object 154, the account object 152, and the service object 160. While service delivery object 158 is described as including multiple fields, some of the described fields can be optional and may not be included in some implementations. In other implementations, the service delivery object 158 may include additional fields without departing from the scope of the implementations described herein.

While the implementations herein are described with each one of the data objects including a set of fields, in other implementations, each one of these data objects may include fewer or additional fields that are not discussed herein.

Each one of the data objects can be a representation of a database object stored in datastore 140. Each database object may include a number of records, and each record may comprise a set of fields. A record may take different forms based on the database model being used and/or the specific database object to which it belongs; for example, a record may be: 1) a row in a table of a relational database; 2) a JavaScript Object Notation (JSON) document; 3) an Extensible Markup Language (XML) document; 4) a key-value pair; etc. A database object can be unstructured or have a structure defined by the DBMS (a standard database object) and/or defined by a user (custom database object). For simplicity and ease of understanding each one of the data objects 152, 154, 156, 158, 160, 162, and 164 is represented with a single corresponding database object, respectively account database object 142, contact database object 144, program engagement database object 146, service delivery database object 148, service database object 180, program database object 182, and program cohort database object 184, in the datastore 140. Additionally or alternatively, in some implementations, instances of one or more of the data objects 152, 154, 156, 158, 160, 162, and 164 may be stored as one or multiple records in one or multiple database objects respectively.

The program management system 150 described herein allows users to enter data as defined based on the data objects of the data model 170 and their respective relationship, which provides an efficient and simplified reporting mechanism in relation to programs. The relationships between the objects enables the generation of reports for answering one or more of the following exemplary questions: 1) How many services did a client receive as part of a given program? How many services did an average client receive? which can be answered by using the program object, the program engagement object, and the service delivery object; 2) How many people are enrolled in my program? which can be answered by using the program object, the program engagement object; 3) How many unique clients did this program reach during a certain time period? During a certain grant reporting period? which can be answered by using the program object and the program engagement object; 4) How do clients in cohort A compare to clients in cohort B? How many services are being provided to these different cohorts? Which can be answered by using the program object, the program engagement object, the program cohort object, and the service delivery object; 5) How many clients enrolled in your program this week? How is that different by location or demographic info? Which can be answered by using the program object, the program engagement object, and the program cohort object; 6) How many services have been delivered this month compared to previous months? Which can be answered by using the service object and the service delivery object; 7) How many clients have dropped out of your program? Why? Which can be answered by using the program object and the program engagement object; 8) How many services did all clients who completed the program receive? Which can be answered by using the program object, the program engagement object, the service delivery object. The questions described herein are provided as examples only and should not be considered a limitation of the present implementations. Other questions and/or reports can be generated based on the data objects and their relationships.

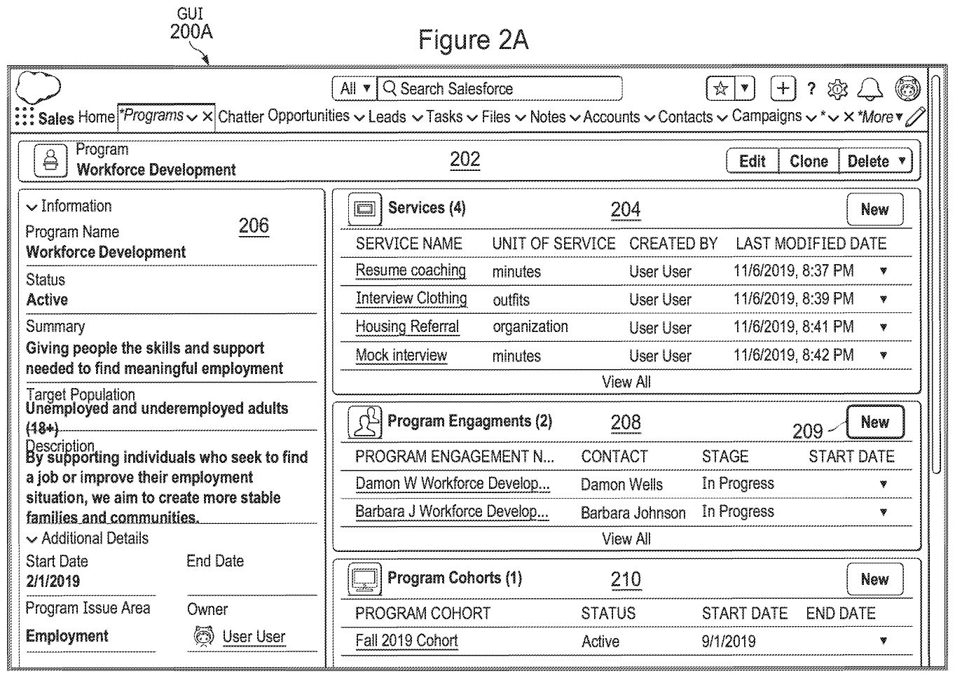

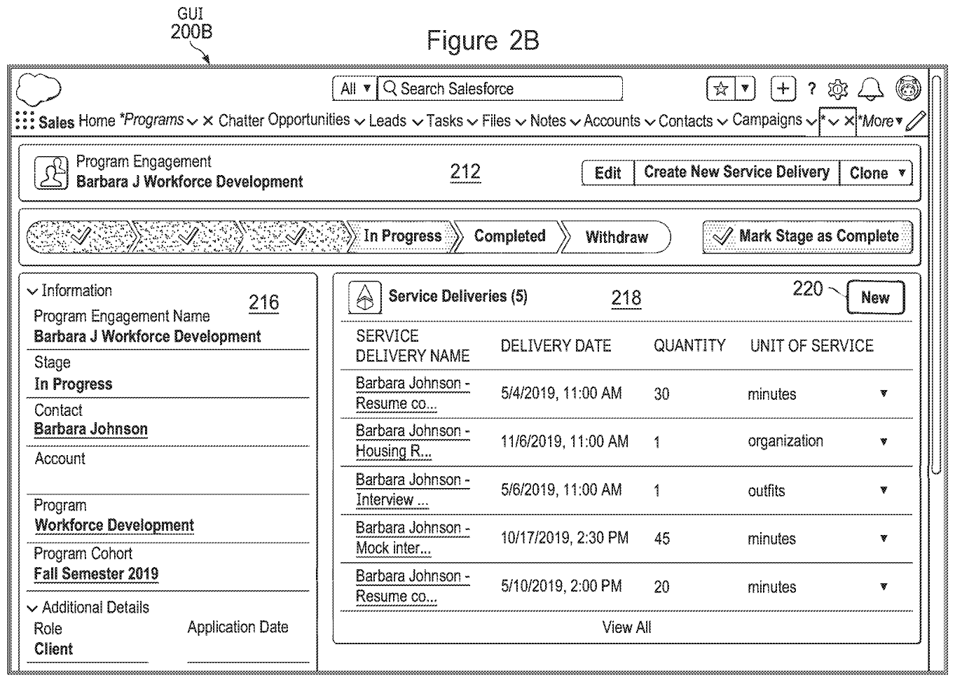

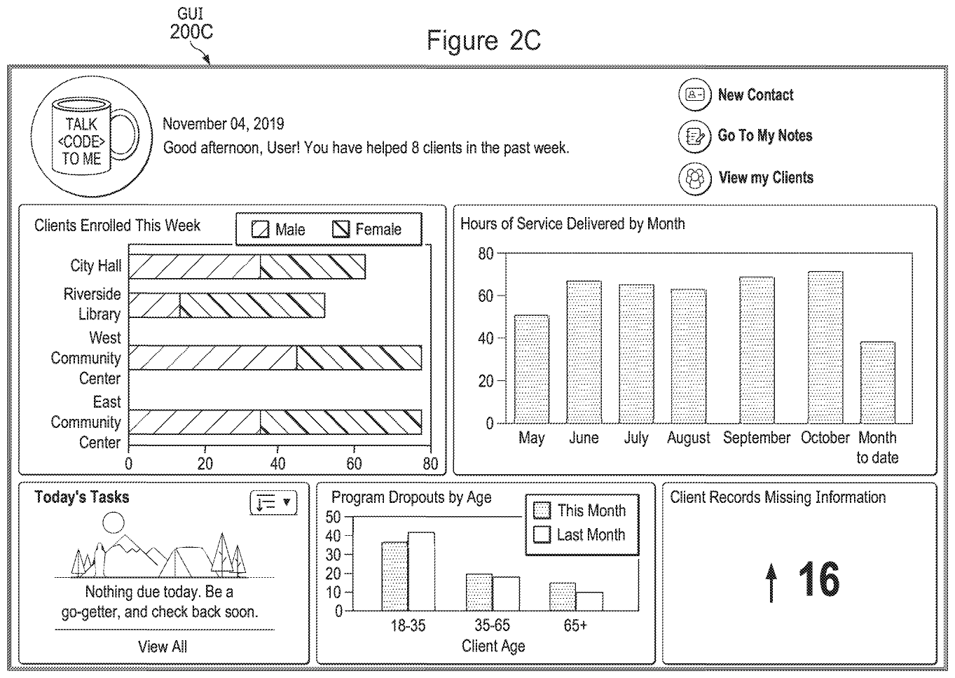

Exemplary graphical user interfaces (GUIs) illustrated in FIGS. 2A-C are described in the following description. The exemplary GUIs will be illustrated as web pages within a web browser. These GUIs are intended to be illustrative and should not be considered as a limitation of the present implementations. Other exemplary GUIs can be used. For example, the GUI can be displayed within a web browser of a mobile device (e.g., web browser of a smartphone). In another example, the GUIs can be displayed on a standalone application (also referred to as “app”) running on a mobile device, or running on a desktop device. Other examples can be contemplated without departing from the scope of the implementations described herein. In the following description, the GUIs of FIGS. 2A-C will be described with reference to operations in the system 100 of FIG. 1. However, the GUIs can be performed by implementations other than those discussed with reference to FIG. 1, and the system of FIG. 1 can perform operations different than can result in graphical user interfaces that are different from the ones described with reference to FIGS. 2A-C.

FIG. 2A illustrates a graphical user interface (GUI) 200A that can be displayed on the customer system 101 and used by a user to access the program management system 150. In the illustrated GUI 200A one or more information that is displayed is a result of one or more requests (e.g., API request) sent from the program management user system 130 to the program management system 150. In some implementations, the program management system 150 is operative to retrieve the data from the program management datastore 140 based on the data model 170. The program management system 150 transmits the data to the program management user system 130 to be displayed as part of the user interface, GUI 200A. The GUI 200A includes an exemplary view of a program 202 with associated information 206, associated set of services 204, and program engagement data 208 that shows how clients are engaged over time in the program. Additional information can be shown to the user on the graphical interface based on the data model 170. For example, the GUI 200A may further include the program cohorts 210 indicating the cohort to which the client belongs. For example, GUI 200A includes a fall 2019 cohort with an active status and a start date of Sep. 1, 2019.

FIG. 2B illustrates a GUI 200B that can be displayed on the customer system 101 and used by a user to access the program management system 150. In the illustrated GUI 200B one or more information that is displayed is a result of one or more requests (e.g., API request) sent from the program management user system 130 to the program management system 150. In some implementations, the program management system 150 is operative to retrieve the data from the program management datastore 140 based on the data model 170. The program management system 150 transmits the data to the program management user system 130 to be displayed as part of the user interface GUI 200B. The GUI 200B includes a program engagement 212 with associated information 216 and associated set of service deliveries 218.

FIG. 2C illustrates a GUI 200C that can be displayed on the customer system 101 and used by a user to access the program management system 150. In the illustrated GUI 200C one or more information that is displayed is a result of one or more requests (e.g., API request) sent from the program management user system 130 to the program management system 150. In some implementations, the program management system 150 is operative to retrieve the data from the program management datastore 140 based on the data model 170. The program management system 150 transmits the data to the program management user system 130 to be displayed as part of the user interface GUI 200C. The GUI 200C includes a dashboard showing information related to programs and services. The information may be provided from data stored in the datastore 140 based on the data model 170.

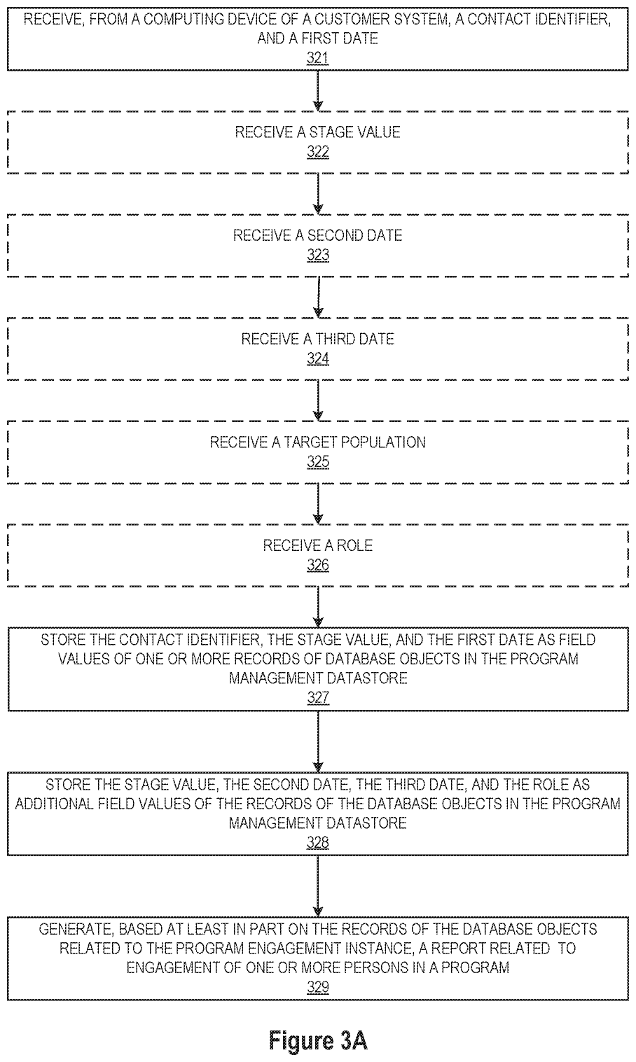

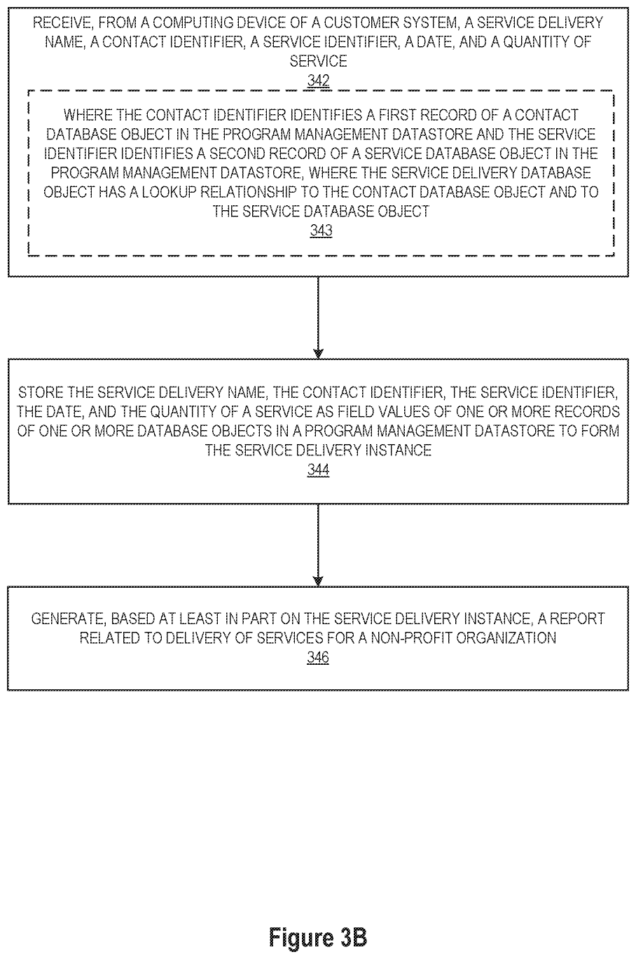

FIG. 3A illustrates a flow diagram of exemplary operations for generation of records associated with the service delivery object 158, in accordance with some implementations. In some implementations, the operations of FIG. 3A can be performed by a program management system 150 as described with reference to the block diagrams of FIGS. 1-2C. In other implementations, the operations of FIG. 3A can be performed by other systems than the one described with respect to FIGS. 1A-2C without departing from the scope of the implementations described herein.

At operation 321, the program management system 150 receives a program identifier, a contact identifier, and a first date. In some implementations, the program management system 150 may further receive a target population, and/or a role. The contact identifier identifies an entity (e.g., a client, a program manager, a volunteer, a doctor, a counselor, etc.) in the program management system 150 for which progress of a program is to be monitored. The contact record includes one or more field values that define a person that is to participate in a program under a given role. In some implementations, the person can be a client that is to participate in a program offered by an organization. In other implementations, the person can be someone that is to manage and/or contribute to a program for clients (e.g., the person can be a volunteer, a program manager, a doctor, a counselor, or any other entity that has a relation with client and the programs). In some implementations, the contact identifier identifies a record in the contact database object 144. The program identifier indicates a program of which progress is to be monitored. For example, the program identifier identifies a program in which a client is participating. The program identifiers may identify a program record in the program database object 182. The first date indicates a date at which a client starts a program.

The flow of operations then moves to operation 322, at which the program management system 150 receives a stage value associated with the program engagement instance. The stage value indicates a level of progress of a program. In some implementations, the stage value indicates a level of progress of a particular client that is enrolled in the program. For example, the stage value can be one of the following values: “Applied” that indicates that the client has applied to participate in the program, “Enrolled” that indicates that the client is enrolled in the program (e.g., that the application to participate in the program has been accepted), “Active” that indicates that the client is actively participating in the program, “Complete” that indicates that the client has completed the program, or “Withdrawn” that indicates that the client has been or has withdrawn from the program and is no longer participating in it. The flow of operations then moves to operation 323, at which the program management system 150 receives a second date associated with the program engagement instance. The second date represents a date at which a client applies for a program. In some implementations, a client does not need to apply to a program and may be enrolled automatically. In these implementations, the second date may not be populated by a user as there is no application process and the operation 3234 can be skipped. In some implementations, the second third date can be received at the program management system 150 along with the program identifier, the contact identifier, and the first date. In other implementations, the second date is not received (e.g., when there is no application process to participate in the program) or received at a later time. The flow of operations then moves to operation 324, at which the program management system 150 receives a third date associated with the program engagement instance. The third date indicates a date at which a client ends a program. The flow of operations then moves to operation 325, at which the program management system 150 receives a target population associated with the program engagement instance. The target population is the name of a population towards which the program is targeted. In some embodiments, the target population is not received. The flow of operations then moves to operation 326, at which the program management system 150 receives a role associated with the program engagement instance. The role (e.g., Client, Volunteer, Staff) identifies the type of the entity engaged in a particular program.

The program identifier, the contact identifier, the stage value, the first date, the second date, the third date, the target population, and/or the role are received from a computing device of a customer system (e.g., customer system 101). For example, a user may use the GUI 200A to add a new program engagement instance. The user may select the graphical interface element 209. The selection of the element 209 results in the display of a GUI that allows the user to enter the program identifier, the contact identifier, the stage value, the first date, the second date, the third date, the target population, and/or the role. The program identifier, the contact identifier, the stage value, the first date, the second date, the third date, the target population, and/or the role are transmitted (e.g., through an API call) from the computing device of the customer system 101 to the program management system 150. In some implementations, the different field values (i.e., the program identifier, the contact identifier, the stage value, the first date, the second date, the third date, the target population, and/or the role) can be received in a single message from the customer system 101. For example, the user of the program management user system 130 may enter all of the field values at once. Alternatively, the different field values (i.e., the program identifier, the contact identifier, the stage value, the first date, the second date, the third date, the target population, and/or the role) can be received over multiple messages from the customer system 101 spread over time. For example, the user may enter some of the field values without entering all of them. In these implementations, the user may be enabled to enter the remaining field values at a different time by updating an existing program engagement instance. For example, upon generating the program engagement instance, the user may enter the following field values program identifier, the contact identifier, and the first date that indicates the date at which the program is started. At a later time, the user may update the program engagement instance by selecting in a GUI the particular program engagement instance and enter the stage value indicating progress made by a client in that program. At a third time, the user may update the program engagement instance and enter a third date indicating the date at which the program is ended. In one example, the user may enter the second date when the process within an organization supports an application for programs.

The flow of operations moves to operation 327, at which the contact identifier, and the first date are stored as field values of one or more records of database objects in the program management datastore 140. The field values of the records including the program identifier, the contact identifier, and the first date form an instance of a program engagement object 156. The flow of operations then moves to operation 328, at which the stage value, the second date, the third date, the target population, and the role are stored as additional field values of the records of the database objects in the program management datastore 140. In some implementations, storing the stage value, the second date, the third date, the target population, and the role in the additional field values can be performed in a single transaction as an update of the record(s) upon receipt of these values from the customer system 101. In other implementations, storing the stage value, the second date, the third date, the target population, and the role can be performed in multiple transactions of multiple updates of the records in the database objects. In some implementations, the program identifier, the contact identifier, the stage value, the first date, the second date, the third date, the target population, and the role are stored as field values of a record of a program engagement database object 148 in the program management datastore 140. In these implementations, an instance of a program engagement object 156 corresponds to a program engagement record in the program engagement database object 146. In other implementations, the contact identifier, the stage value, the first date, the second date, the third date, the target population, and the role are stored as multiple records of multiple database objects in the program management datastore 140. In these implementations, an instance of a program engagement object 156 corresponds to multiple records stored in multiple database objects in the program management datastore 140.

The flow of operations then moves to operation 329, at which a report related to engagement of one or more persons in a program for a non-profit organization is generated based at least in part on the records of the database objects related to the instance of the program engagement object.

In some implementations, the generation of the report includes requesting data (e.g., a database query) from the program management datastore 140 and the retrieval of the data from one or more records that form an instance of a program engagement object. In some implementations, retrieving an instance of a program engagement object includes retrieving one or more field values of a program engagement record from the program engagement database object 146. In some implementations, the generation of the report may further include retrieving field values of one or more additional records from database objects that are linked to the program engagement database object 146 according to the data model 170. For example, this may include the retrieval of field values of records from the service delivery database object 148, the program database object 182, the contact database object 144, the account database object 142, and the program cohort database object 184.

In some implementations, the field values that form the instance of the program engagement object are transmitted to the computing device of the customer system 101. The transmission of the field values causes the display of the program engagement instance on a graphical user interface of the customer system 101 (e.g., element 208 of GUI 200A). Additionally or alternatively, the program engagement instance can be added to a document and/or file that is automatically generated by the program management system 150 without being displayed on a graphical user interface. In some implementations, the generation of a report may include the retrieval of several sets of field values where each set of field values forms a different instance of the program engagement object.

In some implementations, the program engagement object 156 can be used to show that a client is enrolled in a program, a volunteer is actively working with a program offering, or a referral partner is closely tied to a program offering. Additionally or alternatively, the program engagement object 156 can be used by the program management system 150 to determine the clients that are engaged with a particular program. For example, the program management system 150 may be operative to generate a report to a user of the organization 102A on the multiple clients that are engaged in a particular program by looking up records of database objects associated with the contact object 154 and the program engagement object 156 greatly simplifying the report generation processes with respect to program engagement. The program engagement object 156 also allows to track an individual's progress through a program by showing what stage they are in (e.g., “applied,” “active”, “complete,” etc.).

FIG. 3B illustrates a flow diagram of exemplary operations for generation of records associated with the service delivery object 158, in accordance with some implementations. In some implementations, the operations of FIG. 3B can be performed by a program management system 150 as described with reference to the block diagrams of FIGS. 1-2C. In other implementations, the operations of FIG. 3A can be performed by other systems than the one described with respect to FIG. 1A-2C without departing from the scope of the implementations described herein.

At operation 342, the program management system 150 receives a service delivery name, an identifier of a contact record, an identifier of a service record, a date, and a quantity of a service. The service delivery name is a name that is entered by a user for a service delivery instance in which a service is delivered to a client. The identifier of the contact record (or contact identifier) identifies a record in the contact database object 144. The contact record includes one or more field values that define a person that is related to the service. In some implementations, the person can be a client that is to receive the service. In other implementations, the person can be someone that is to deliver a service to a client (e.g., the person can be a volunteer, a program manager, an organization, or any other entity that has a relation with a service). The identifier of the service record (or service identifier) identifies a record in the service database object 180 that is to be monitored. For example, the service identifier identifies a particular service that is delivered to a client. The date includes the date at which the service is delivered to the client. The quantity of service delivered is a value (e.g., in terms of the number of unit of measurement) that indicates the quantity of service that is delivered to the client at the given date. The service delivery name, the contact identifier, the service identifier, the date, and the quantity of a service are received from a computing device of a customer system (e.g., customer system 101). For example, a user may use the GUI 200B to add a new service delivery. The user may select the graphical interface element 220. The selection of the element 220 results in the display of a GUI that allows the user to enter the service delivery name, the contact identifier, the service identifier, the date, and the quantity of a service. The service delivery name, the identifier of a contact, the identifier of a service, the date, and the quantity of a service are transmitted (e.g., through an API call) to the program management system 150. In some implementations, the user may enter some of the field values without entering all of them. In these implementations, the user is enabled to enter the remaining field values at a different time by updating an existing service delivery instance.

The flow of operations moves to operation 344, at which the service delivery name, the contact identifier, the service identifier, the date, and the quantity of a service are stored as field values of one or more records of database objects in a program management datastore. The field values of the records including the service delivery name, the contact identifier, the service identifier, the date, and the quantity of a service form an instance of a service delivery object 158. In some implementations, the service delivery name, the contact identifier, the service identifier, the date, and the quantity of a service are stored as field values of a record of a service delivery database object 148 in the program management datastore 140. In these implementations, an instance of a service delivery object 158 corresponds to a service delivery record in the service delivery database object. The service delivery database object has a lookup relationship to the contact database object and to the service database object. In other implementations, the service delivery name, the contact identifier, the service identifier, the date, and the quantity of a service are stored as multiple records of multiple database objects in the program management datastore 140. In these implementations, an instance of a service delivery object 158 corresponds to multiple records stored in multiple database objects in the program management datastore 140.

The flow of operations then moves to operation 346, at which a report related to delivery of services for a non-profit organization is generated based at least in part of the records of the database objects related to the instance of the service delivery object.

In some implementations, the generation of the report includes a request for data (e.g., a database query) from the program management datastore 140 and the retrieval of the data from the record(s) that form an instance of a service delivery object in the program management datastore 140. In some implementations, retrieving an instance of a service delivery object includes retrieving the field values of a service delivery record from the service delivery database object 148. In some implementations, generation of the report may further include retrieving field values of one or more additional records from database objects that are linked to the service delivery database object 148 according to the data model 170. For example, this may include the retrieval of records from the program engagement database object 146, the contact database object 144, the account database object 142, and the service database object 180.

In some implementations, the field values that form the instance of the service delivery object are transmitted to the computing device. The transmission of the field values causes the display of the service delivery instance on a graphical user interface of the customer system 101 (e.g., element 218 of GUI 200B). Additionally or alternatively, the service delivery instance can be added to a document and/or file that is automatically generated by the program management system 150 without being displayed on a graphical user interface. In some implementations, the generation of a report may include the retrieval of several sets of field values where each set of field values forms a different instance of the service delivery object resulting in the report including several instances of the service delivery object.

In some implementations, each time a service is delivered a new service delivery record is created by a user of the program management system 150 to record an instance of the delivered service. The service delivery database object 148 can be seen as a ledger or log of all the services that have been delivered to a client or the community of clients over time for a given organization. The generation of a service delivery instance captures through the fields of the record(s) stored in the program management datastore 140 for the service delivery instance who received a service, when and in what quantity.

The program management system 150 provides a framework that can be used to connect program delivery tools across a nonprofit ecosystem. The program management system 150 is built upon a standardized data architecture that enables nonprofits and/or other organizations to centralize and connect the tools they are using to manage program and service delivery. The data model/architecture on which the program management system 150 is built defines data objects and relationships between these data objects that enable support of a wide variety of programs and services that nonprofits and/or organizations are delivering, whether these organizations work with clients or run advocacy programs.

The program management system 150 allows management of service delivery-related operations by tracking program engagements and delivery of services to clients of an organization. The program management system 150 allows the organization to obtain a global view of the clients they support and how these clients interact with the services and the programs. The program management system 150 enables the organization to store the program data in a central place that is visible to users across the organization in real time. The system 150 further allows cross-sector collaboration by storing program data based on a standardized data model 170, consequently allowing nonprofits and organizations to share data and problems with their peers and other entities.

The program management system 150 described herein allows users to enter data as defined based on the data objects of the data model 170 and their respective relationships, which provides an efficient and simplified reporting mechanism in relation to programs and services delivered as part of these programs. The relationships between the objects enables the generation of reports for answering one or more of the following questions: 1) How many services did a client receive as part of a given program? How many services did an average client receive? which can be answered by retrieving data from records in the program management datastore 140 associated with the program object, the program engagement object, and the service delivery object; 2) How many people are enrolled in my program? which can be answered by retrieving data from records in the program management datastore 140 associated the program object, the program engagement object; 3) How many unique clients did this program reach during a certain time period? During a certain grant reporting period? which can be answered by retrieving data from records in the program management datastore 140 associated with the program object and the program engagement object; 4) How do clients in cohort A compare to clients in cohort B? How many services are being provided to these different cohorts? Which can be answered by retrieving data from records in the program management datastore 140 associated with the program object, the program engagement object, the program cohort object, and the service delivery object; 5) How many clients enrolled in your program this week? How is that different by location or demographic info? Which can be answered by retrieving data from records in the program management datastore 140 associated with the program object, the program engagement object, and the program cohort object; 6) How many services have been delivered this month compared to previous months? Which can be answered by retrieving data from records in the program management datastore 140 associated with the service object and the service delivery object; 7) How many clients have dropped out of your program? Why? Which can be answered by retrieving data from records in the program management datastore 140 associated with the program object and the program engagement object; 8) How many services did all clients who completed the program receive? Which can be answered by retrieving data from records in the program management datastore 140 associated with the program object, the program engagement object, the service delivery object. The questions described herein are provided as examples only and should not be considered a limitation of the present implementations. Other questions and/or reports can be generated based on the data objects and their relationships.

While implementations are described herein with a data model that includes the program engagement object, the service delivery object and the program cohort object as tools for facilitating reporting of client activity with respect to service delivery and program participation, in other implementations different data models may be used. For example, the data model may include only the program engagement object, only the service delivery object, or only the program cohort object as a tool for facilitating reporting. In other examples, two of the objects may be used in combination in a single data model to facilitate the reporting of client activity and program participation in an organization. The program engagement object, the service delivery object and the program cohort can be used independently or in combination without departing from the scope of the implementations described herein.

Electronic Device and Machine-Readable Media

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

Example Environment

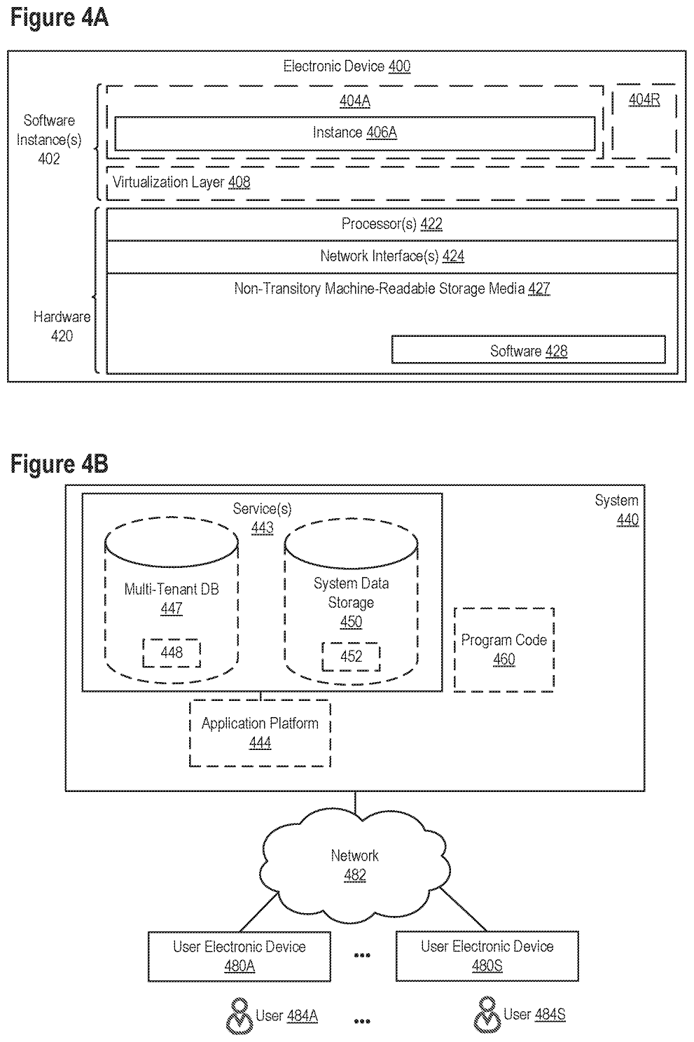

FIG. 4A is a block diagram illustrating an electronic device 400 according to some example implementations. FIG. 4A includes hardware 420 comprising a set of one or more processor(s) 422, a set of one or more network interfaces 424 (wireless and/or wired), and non-transitory machine-readable storage media 426 having stored therein software 428 (which includes instructions executable by the set of one or more processor(s) 422). Each of the previously described services and resources of the program management system itself may be implemented in one or more electronic devices 400. In one implementation: 1) each of the end user clients (e.g., the customer system 101) is implemented in a separate one of the electronic devices 400 (e.g., in user electronic devices operated by users of the tenant organization or organizations with supporting roles where the software 428 represents the software to implement end user clients to interface with the services and resources of the program management system (e.g., a web browser, a native client, a portal, a command-line interface, and/or an application program interface (API) based upon protocols such as Simple Object Access Protocol (SOAP), Representational State Transfer (REST), etc.)); 3) the services and resources of the program management system can be implemented in a separate set of one or more of the electronic devices 400 (e.g., a set of one or more server electronic devices where the software 428 represents the software to implement the service and resources of the program management system); and 3) in operation, the electronic devices implementing the end user clients and the program management services and resources would be communicatively coupled (e.g., by a network) and would establish between them (or through one or more other layers) connections for submitting resource requests to the authorization points and returning a set of permissions to the authorization points and end user clients. Other configurations of electronic devices may be used in other implementations (e.g., an implementation in which the end user client and the program management system services are implemented on a set of shared electronic devices 400).

In electronic devices that use compute virtualization, the set of one or more processor(s) 422 typically execute software to instantiate a virtualization layer 408 and software container(s) 404A-R (e.g., with operating system-level virtualization, the virtualization layer 408 represents the kernel of an operating system (or a shim executing on a base operating system) that allows for the creation of multiple software containers 404A-R (representing separate user space instances and also called virtualization engines, virtual private servers, or jails) that may each be used to execute a set of one or more applications; with full virtualization, the virtualization layer 408 represents a hypervisor (sometimes referred to as a virtual machine monitor (VMM)) or a hypervisor executing on top of a host operating system, and the software containers 404A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 428 (illustrated as instance 406A) is executed within the software container 404A on the virtualization layer 408. In electronic devices where compute virtualization is not used, the instance 406A on top of a host operating system is executed on the “bare metal” electronic device 400. The instantiation of the instance 406A, as well as the virtualization layer 408 and software containers 404A-R if implemented, are collectively referred to as software instance(s) 402.

Alternative implementations of an electronic device may have numerous variations from that described above. For example, customized hardware and/or accelerators might also be used in an electronic device.

FIG. 4B is a block diagram of an environment where an end user clients or services and resources of the program management system may be deployed, according to some implementations. A system 440 includes hardware (a set of one or more electronic devices) and software to provide service(s) 442, including the implied program management system. The system 440 is coupled to user electronic devices 480A-S over a network 482. The service(s) 442 may be on-demand services that are made available to one or more of the users 484A-S working for one or more other organizations (sometimes referred to as outside users) so that those organizations do not need to necessarily be concerned with building and/or maintaining a system, but instead makes use of the service(s) 442 when needed (e.g., on the demand of the users 484A-S). The service(s) 442 may communication with each other and/or with one or more of the user electronic devices 480A-S via one or more Application Programming Interface(s) (APIs) (e.g., a Representational State Transfer (REST) API). The user electronic devices 480A-S are operated by users 484A-S.

In one implementation, the system 440 is a multi-tenant cloud computing architecture supporting multiple services, such as those of a program management system. In other implementations, similar services can be applied to other services deployed in similar architectures such as customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 440 may include an application platform 444 that enables PAAS for creating, managing, and executing one or more applications developed by the provider of the application platform 444, users accessing the system 440 via one or more of user electronic devices 480A-S, or third-party application developers accessing the system 440 via one or more of user electronic devices 480A-S.

In some implementations, one or more of the service(s) 442 may utilize one or more multi-tenant databases 446 for tenant data 448, as well as system data storage 450 for system data 452 accessible to system 440. In certain implementations, the system 440 includes a set of one or more servers that are running on server electronic devices and that are configured to handle requests for any authorized user associated with any tenant (there is no server affinity for a user and/or tenant to a specific server). The user electronic device 480A-S communicate with the server(s) of system 440 to request and update tenant-level data and system-level data hosted by system 440, and in response the system 440 (e.g., one or more servers in system 440) automatically may generate one or more Structured Query Language (SQL) statements (e.g., one or more SQL queries) that are designed to access the desired information from the one or more multi-tenant database 446 and/or system data storage 450.

In some implementations, the service(s) 442 are implemented using virtual applications dynamically created at run time responsive to queries from the user electronic devices 480A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 460 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 444 includes an application setup mechanism that supports application developers' creation and management of applications, which may be saved as metadata by save routines. Invocations to such applications, including the program management service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 482 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 440 and the user electronic devices 480A-S.

Each user electronic device 480A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 440. For example, the user interface device can be used to access data and applications hosted by system 440, and to perform searches on stored data, and otherwise allow a user 484 to interact with various GUI pages that may be presented to a user 484. User electronic devices 480A-S might communicate with system 440 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 480A-S might include an HTTP client, commonly referred to as a “browser,” for sending and receiving HTTP messages to and from server(s) of system 440, thus allowing users 484 of the user electronic device 480A-S to access, process and view information, pages and applications available to it from system 440 over network 482.

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A computer implemented method in a program management system, the method comprising:
receiving, from a computing device of a customer system, a service delivery name, a contact identifier, a service identifier, a date, and a quantity of service, wherein the service delivery name is a name of a service delivery instance that represents a service that is delivered to a client, the service identifier identifies a service of which progress is to be followed, the contact identifier identifies a person that is in relation to the service, the date includes a date at which the service is delivered, and the quantity of service is a value that indicates the quantity of service that is delivered at the date;
storing the service delivery name, the contact identifier, the service identifier, the date, and the quantity of service as field values of one or more records of one or more database objects in a program management datastore to form the service delivery instance; and
generating, based at least in part on the service delivery instance, a report related to delivery of services for a non-profit organization.

2. The method of claim 1, wherein the service delivery instance is a record in a service delivery database object of the program management datastore.

3. The method of claim 2, wherein the contact identifier identifies a first record of a contact database object in the program management datastore and the service identifier identifies a second record of a service database object in the program management datastore, and wherein the service delivery database object has a lookup relationship to the contact database object and to the service database object.

4. The method of claim 1, wherein the field values of the records are first field values of the first records, and the method further comprises:
receiving, from the computing device of the customer system, a program identifier that identifies a program of which progress is to be monitored, the contact identifier, and a first date that represents a date at which participant in the program starts; and
storing the program identifier, the contact identifier, and the first date as second field values of one or more second records of second database objects in the program management datastore to form a program engagement instance.

5. The method of claim 4 further comprising:
receiving a stage value associated with the program engagement instance, wherein the stage value indicates progress in the program.

6. The method of claim 4 further comprising:
receiving a second date associated with the program engagement instance, wherein the second date indicates a date at which an application for participation in the program is received.

7. The method of claim 4 further comprising:
receiving a third date associated with the program engagement instance, wherein the third date indicates a date at which the client ends the program.

8. The method of claim 7 further comprising:
generating, based at least in part on the program engagement instance, a second report related to engagement of one or more persons in the program.

9. The method of claim 4, wherein the program engagement instance is a record in a program engagement database object.

10. A non-transitory machine-readable storage medium that provides instructions that, if executed by a processor in a program management system, will cause said processor to perform operations comprising:
receiving, from a computing device of a customer system, a service delivery name, a contact identifier, a service identifier, a date, and a quantity of service, wherein the service delivery name is a name of a service delivery instance that represents a service that is delivered to a client, the service identifier identifies a service of which progress is to be followed, the contact identifier identifies a person that is in relation to the service, the date includes a date at which the service is delivered, and the quantity of service is a value that indicates the quantity of service that is delivered at the date;
storing the service delivery name, the contact identifier, the service identifier, the date, and the quantity of service as field values of one or more records of one or more database objects in a program management datastore to form the service delivery instance; and
generating, based at least in part on the service delivery instance, a report related to delivery of services for a non-profit organization.

11. The non-transitory machine-readable storage medium of claim 10, wherein the service delivery instance is a record in a service delivery database object of the program management datastore.

12. The non-transitory machine-readable storage medium of claim 11, wherein the contact identifier identifies a first record of a contact database object in the program management datastore and the service identifier identifies a second record of a service database object in the program management datastore, and wherein the service delivery database object has a lookup relationship to the contact database object and to the service database object.

13. The non-transitory machine-readable storage medium of claim 10, wherein the field values of the records are first field values of the first records, and the method further comprises:
receiving, from the computing device of the customer system, a program identifier that identifies a program of which progress is to be monitored, the contact identifier, and a first date that represents a date at which participant in the program starts; and
storing the program identifier, the contact identifier, and the first date as second field values of one or more second records of second database objects in the program management datastore to form a program engagement instance.

14. The non-transitory machine-readable storage medium of claim 13, wherein the operations further comprise:
receiving a stage value associated with the program engagement instance, wherein the stage value indicates progress in the program.

15. The non-transitory machine-readable storage medium of claim 13, wherein the operations further comprise:
receiving a second date associated with the program engagement instance, wherein the second date indicates a date at which an application for participation in the program is received.

16. The non-transitory machine-readable storage medium of claim 13, wherein the operations further comprise:
receiving a third date associated with the program engagement instance, wherein the third date indicates a date at which the client ends the program.

17. The non-transitory machine-readable storage medium of claim 16, wherein the operations further comprise:
generating, based at least in part on the program engagement instance, a second report related to engagement of one or more persons in the program.

18. The non-transitory machine-readable storage medium of claim 13, wherein the program engagement instance is a record in a program engagement database object.
